(19) United States
(12) Patent Application Publication
(10) Pub. No.: US 2024/0301971 A1
(43) Pub. Date: Sep. 12, 2024

(54) IMPROVEMENTS IN AND RELATING TO COUPLINGS

(71) Applicant: JCCO 330 LIMITED, Manchester (GB)

(72) Inventor: Paul Davidson, Manchester (GB)

(21) Appl. No.: 17/754,903

(22) PCT Filed: Oct. 14, 2020
(86) PCT No.: PCT/GB2020/052576

§ 371 Date: Apr. 15, 2022

(30) Foreign Application Priority Data
Oct. 17, 2019 (GB) 1915047.3

(51) Int. Cl. F16L 3/11; F16B 7/18; F16B 21/18

(52) U.S. Cl. CPC F16L 3/11; F16B 7/182; F16B 21/186

(57) ABSTRACT

Disclosed is a retaining device comprising a pair of complementary members (1′) arranged such that when placed adjacent to each other. the retaining device is substantially annular and relatively elongate and comprises towards a first end thereof an inner circumferential ridge and an outer circumferential projection. and towards a second end thereof. means for connecting the pair of members, wherein adjacent said second end thereof there is provided a threaded portion (110) for receiving a nut.

The present invention relates to an improved coupling device, which may, in particular, be utilised to retain one or more other parts in a fixed position. Embodiments of the invention find particular use within a suspension system. Such a suspension system is typically used in connection with pipe or cable networks which are suspended from a ceiling or from a bracket on a wall or other upright surface.

Such a system, known in the prior art, typically comprises a system of brackets, mounting points and rods, connected between the pipe/cable or tray carrying the pipe/cable, and the support. Such networks are frequently found in basements, cellars, ceiling voids and the like. The pipes in question may be used for conveying water, waste, gas or any other fluid which needs to be carried from one point to another in a building. The cable may be power, data, fibre optic or otherwise signal or power cable.

In the prior art, pipe support brackets are attached around a pipe and a coupling point located at the top of the bracket is connected to a length of threaded rod which is screwed into the bracket at a first end, and to a support point at a second end. The support point may be in the form of an anchor provided in a ceiling or in the form of a bracket extending from a wall. The anchor in the ceiling may be a specific fastener which is permanently installed in the ceiling, or may be in the form of an attachment to a rail system.

Instead of attaching directly to a pipe, the rod may support a tray which carries pipes and/or cables. The pipes and/or cables may be fastened to the tray. Multiple layers of trays may be provided within a single anchor system.

A particular problem in installing prior art pipe support or hanging systems is that work is performed overhead, which can be strenuous and awkward. The threaded rods which are routinely used to couple the pipe bracket or tray to the support structure require cutting to length using a hacksaw, which often results in sharp portions remaining, which can pose an injury risk to an installer. Screwing in the rods and adding locking bolts is time consuming and awkward.

In a co-pending application, a coupling system is disclosed for use in suspension systems. It is an aim of embodiments of the present invention to provide an improved component for use in such a system and, hence, an improved system.

It is a further aim of embodiments of the present invention to address shortcomings in the prior art, whether mentioned herein or not.

According to the present invention there is provided an apparatus and method as set forth in the appended claims. Other features of the invention will be apparent from the dependent claims, and the description which follows.

According to a first aspect of the present invention there is provided retaining device comprising a pair of complementary members arranged such that when placed adjacent to each other, the retaining device is substantially annular and relatively elongate and comprises towards a first end thereof an inner circumferential ridge and an outer circumferential projection, and towards a second end thereof, means for connecting the pair of members, wherein adjacent said second end thereof there is provided a threaded portion for receiving a nut.

In an embodiment, the means for connecting the pair of members comprises a circumferential channel arranged to receive a fastening means.

In an embodiment, the fastening means is an O-ring or a spring clip.

In an embodiment, each of the complementary members has a chamfered portion arranged to face a similarly chamfered portion of the other complementary member.

In an embodiment, the chamfered portion is located towards the second end and on an inward facing surface.

In an embodiment, the chamfered portions are arranged such that when means for connecting the pair of members is attached, the retaining device assumes a generally open configuration.

In an embodiment, there is further provided a plurality of inner circumferential ridges.

In an embodiment, there is further provided a nut.

In an embodiment, the nut comprises a relatively elongate body comprising a means to engage with a tightening tool and further comprising an aperture arranged such that a castellated rod with pass therethrough.

In an embodiment, the nut is dimensioned such that when fully tightened, the retaining device is configured to assume a fully locked and relatively rigid configuration.

In an embodiment, there is provided a suspension system comprising the retaining device of the first aspect, a receiver or connector arranged to receive the retaining device and a castellated rod.

According to a second aspect of the present invention, there is provided a method of assembling a system comprising the retaining device of any preceding claim, comprising steps of: providing a receiver or connector to receive a retaining device; inserting the retaining device into the receiver or connector; inserting a castellated rod into the receiver or connector such that it engages with the retaining device; moving the castellated rod in an opposite direction to the insertion direction; and affixing a nut to the exposed end of the retaining device and tightening such that the system becomes relatively fixed and rigid.

For a better understanding of the invention, and to show how embodiments of the same may be carried into effect, reference will now be made, by way of example, to the accompanying diagrammatic drawings in which:

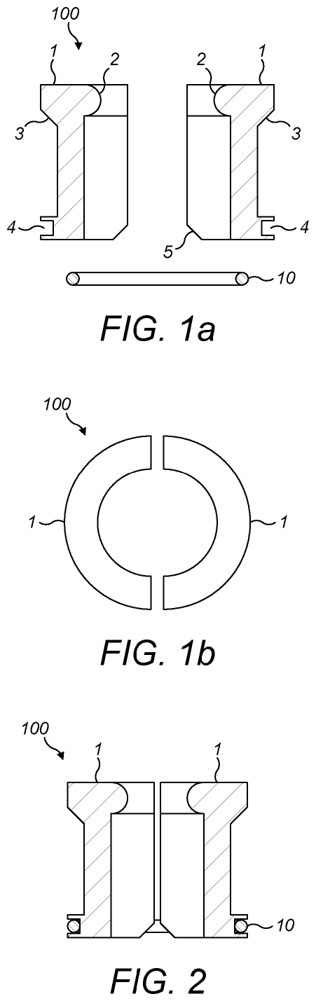

FIGS. 1a and 1b show views of a retaining device according to an embodiment of the present invention;

FIG. 2 shows an assembled view of an embodiment of the present invention;

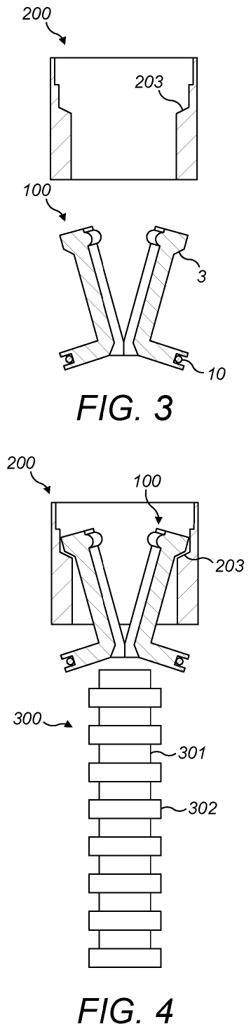

FIG. 3 shows an embodiment of the present invention in use;

FIG. 4 shows an embodiment of the present invention in use;

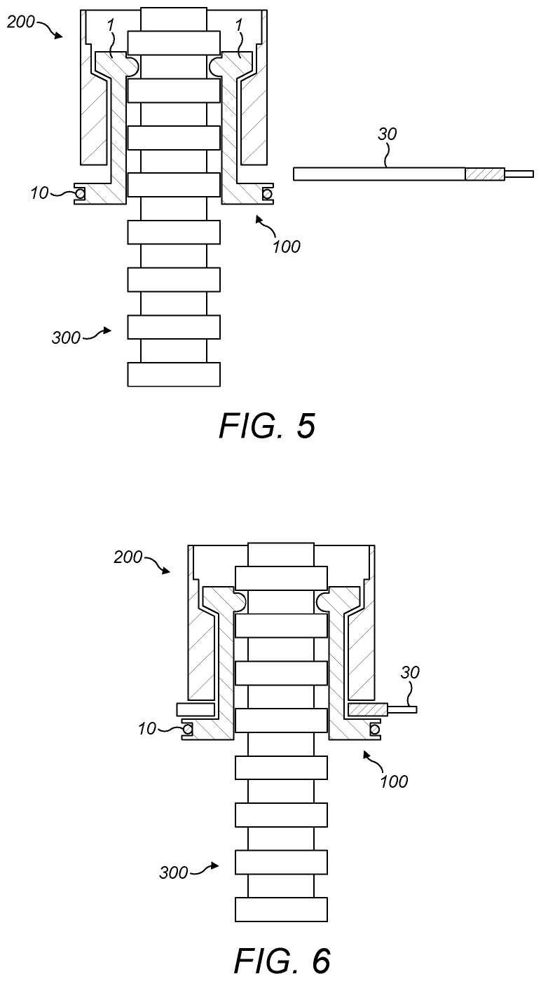

FIG. 5 shows an embodiment of the present invention in use;

FIG. 6 shows a completed assembly of an embodiment of the present invention;

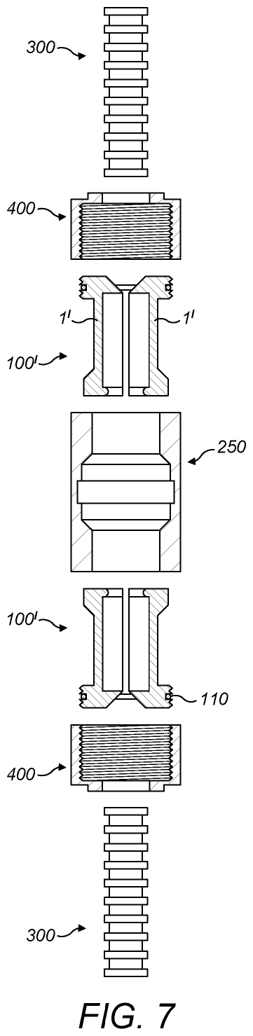

FIG. 7 shows an exploded view of an embodiment of the present invention;

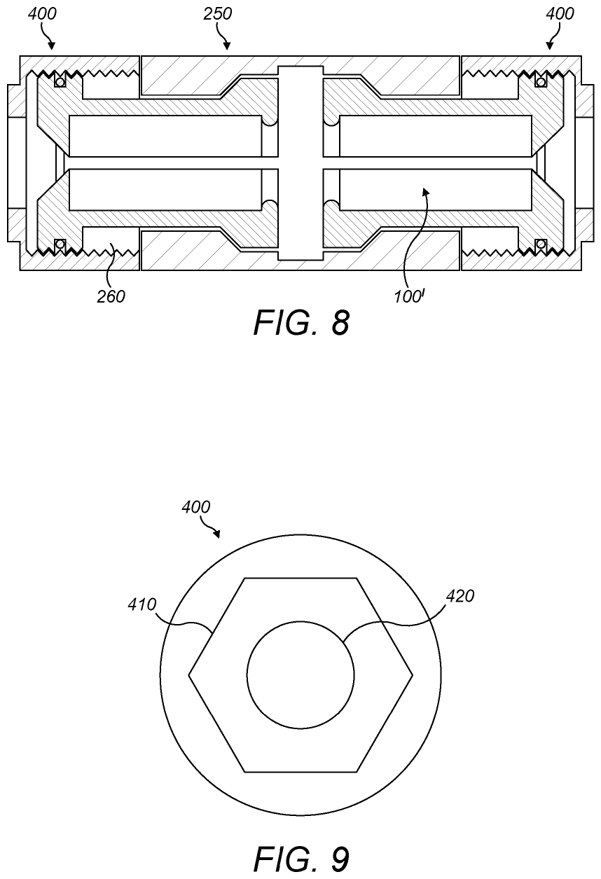

FIG. 8 shows a section detailed view of an assembled embodiment of the invention;

FIG. 9 shows an end view of a component according to an embodiment of the present invention; and

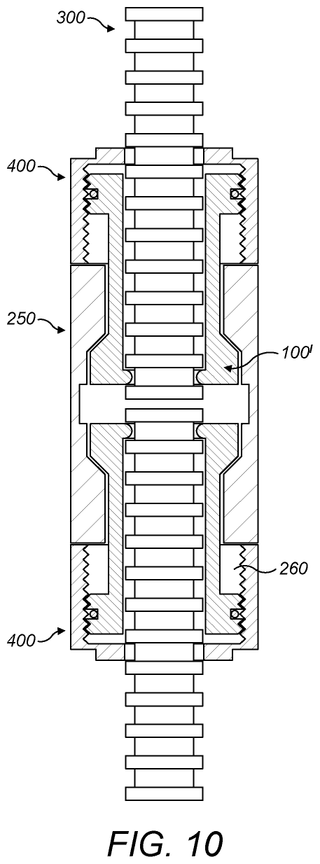

FIG. 10 shows a sectional view of a fully assembled embodiment of the present invention.

FIG. 1a shows cross-sectional view of a retaining device 100 according to an embodiment of the present invention. It comprises a matching pair of members 1. FIG. 1b shows a plan view from above, revealing that the device 100 comprises matching semi-annular members 1 arranged to form a complete annulus, with a central axial aperture, when assembled.

Each member 1 comprises an inner circumferential ridge 2 adjacent an upper part of the member. The ridge 2 is substantially curved and is arranged to protrude into an inner hollow of the member 1. The ridge may be continuous or discontinuous i.e. a series of projections.

Each member also comprises an outer circumferential projection 3 which comprises an angled lower portion. The projection may be continuous or discontinuous i.e. a series of projections.

Each member comprises a channel 4 adjacent a lower part of the member. The channel forms a complete circular recess once the two members 1 are placed adjacent each other as shown in FIG. 2. An O-ring 10 is provided to sit in the channel 4 and maintain the two members in close proximity for use.

The members are preferably formed from a metal, most preferably steel. They are formed to be fireproof and able to withstand high temperatures and to be mechanically strong.

The O-ring 10 may be formed from a resilient material, preferable a rubber, elastic or silicone material, which enables it to be fitted into the channel 4 and maintain both members 1 in close proximity.

FIG. 3 shows a receiver 200, which is arranged to receive the retaining device 100. The receiver 200 is formed from the same material as the retaining device 100 and is substantially cylindrical with a central aperture to receive the retaining device 100. The aperture is relatively wider at an upper end, and the transition between the lower narrower part and the upper wider part is marked by angled surface 203.

The receiver 200 is arranged to be attached to a supporting surface. The supporting surface may suitably by a ceiling and it may be attached thereto by means of a fastening such as a screw or bolt (not shown) which passes through an upper surface of the receiver 200 and into the supporting surface. A fixing aid such as a plug, anchor or similar may be provided if necessary, to provide a secure fixing. The receiver may, alternatively, be integrally formed with an attachment device so that the entire receiver may be attached to a suitable surface. This may take the form of an integral screw element, for instance. In a still further embodiment, the receiver 200 is arranged to itself be received into a pre-positioned rail system, allowing a plurality of receivers 200 to be positioned in the rail in an elongate manner. Essentially, the receiver may be fastened in any number of ways to a supporting surface, The details of such attachment are intendent of the operation of embodiments of the invention.

In use, the retaining device 100 is inserted into the receiver 200. To do this, the upper parts of the device 100 are pressed towards each other. This requires minimal force and may be provided easily in a manual manner with no tool required. Once in this ‘closed’ position, the upper part of the retaining device 100 is inserted into the receiver 200. This is illustrated in FIG. 4. Once the upper part of retaining device 100 is inserted, it naturally reverts to the default ‘open’ configuration as shown. In this way, the retaining device is temporarily retained loosely within the receiver. It is prevented from falling out by a combination of the force which tends to hold it in the ‘open’ position and the cooperation of the outer circumferential projection 3 which comprises an angled lower portion which rests on the angled surface 203.

With the retaining device 100 retained in the receiver, the next step is to introduce castellated rod 300. The rod 300 is elongate and of a width to be accommodated within the retaining device 100. Along at least a part of its length it has alternating protruding portions 302 and recessed or waisted portions 301.

In order to insert the rod 300 into the retaining device 100, it is necessary to provide sufficient upward force to overcome the biasing force provided by the O-ring 10 or spring clip 11. In this way, the rod penetrates the retaining device and travels upwards until it reaches the upper portion of the receiver 200. Once in this position, the upper parts of the retaining device are forced relatively inwards, towards each other, and the inner circumferential ridge 2 is urged towards the rod 300 and naturally engages with the waisted portion 301. This is shown in FIG. 5.

As can be seem, the two members 1 are now substantially parallel with each other and the retaining device 100 fits snugly around the rod 300, In this configuration, downward force on the rod 300 actually serves to secure the retaining device 100 more securely in position. In order to lock the configuration, locking member 30 is positioned between the opposed lower surfaces of the retaining device 100 and receiver 200 as shown. Locking member 30 is formed in a substantially planar C-shape and is dimensioned to be resiliently deformable and is held in position by its natural resilience. It can be formed from metal, such as steel, for fire-safe applications. In other applications, it can be formed from a plastic material.

As long as there is a steady downward force on the rod 300, it will remain static. The locking member 30 is provided for additional stability and can guard against vibrations.

With the locking member 30 in place, as shown in FIG. 6, the relative positions of the various elements is controlled and the rod 300 is fixed relative to the receiver 200.

The elongate rod can then be coupled to the tray, pipe or cable which is to be suspended. In order to couple to e.g. a tray, then the same receiver 200, retaining device 100 and locking member 30 can be used to anchor the distal end of the rod.

In order to disassemble the arrangement shown in FIG. 6, the steps involved in the assembly are effectively reversed. Firstly, the locking member 30 is removed by withdrawing it sideways. This allows a small degree of relative movement between the rod 300 and retaining device 100 on one hand, and the receiver 200 on the other. In order to withdraw the rod 300, the retaining device is urged upwards so that it is fully inserted into the receiver 200. This provides additional space at the upper portion of the receiver, into which the upper parts of retaining device 100 can move as the rod 300 is pulled downwards. During the pulling downwards operation, the retaining device 100 is urged upwards to ensure that the rod 300 can be withdrawn. Once the rod 300 is withdrawn, the retaining device 100 can be simply withdrawn.

The materials selected e.g. steel or other metal, for the retaining device 100, receiver 200 and rod 300 ensure that the entire assembly is fireproof or at least fire resistant. In the event of a fire, the O-ring 10 may perish, but once the assembly is complete as shown in FIG. 9, the O- ring serves no structural purpose and is only provided to ease assembly in the first place.

In the foregoing embodiment, in order to ensure an appropriate spacing is maintained between the receiver 200 and the retaining device 100, locking member 30 is used. However, a further embodiment in provided which achieves the same effect and additionally provides improved coupling of all component parts.

FIG. 7 shows an exploded view of a means for connecting two rods 300 by means of a connector 250. The connector 250 may be considered as two receivers 200 connected back to back. The mode of operation of each half of the connector 250 is identical to that already described and so is not repeated here.

In FIG. 7, retaining device 100′ differs from retaining device 100 described already in that at the end in which the O-ring 10 is located, an external thread 110 is provided. This surrounds the slot in which the O-ring sits. The thread 110 is arranged to engage with an internal thread on nut 400.

Once retaining device 100′ is inserted into connector 250, it is retained, as described previously. Then, rod 300 is introduced, and the retaining device 100′ engages with the projections and waisted portions of rod 300. In this configuration, rod 300 can be easily removed. In order to secure it in place, its position relative to the retaining device 100′ and connector 250 required fixing.

To achieve this, nut 400 is introduced. FIG. 9 shows an end view of nut 400. It comprises a generally cylindrical portion with a threaded interior. This cylindrical portion is arranged to enclose at least a portion of the retaining device 100′. Projecting from the cylindrical portion is a hexagonal section 410, provided for engagement with a spanner, wrench, pliers or other tightening tool. An aperture 420 is provided so that the rod 300 can penetrate the nut 400. The aperture 420 is dimensioned such that the rod can pass easily therethrough.

Although exemplified here as a cylinder with a hexagonal projection, the entirety of the exterior of the nut 400 may be provided in hexagonal form to accommodate a spanner. Alternatively, it may be provided as a cylinder with opposed flattened surfaces to accommodate a spanner. Essentially, it should include an internal thread to engage with the retaining device 100′ and have means provided to engage with a spanner or other tool to tighten it once fitted.

FIG. 8 shows the connector 250 with a retaining device 100′ fitted to each end of the connector 250. The rod 300 has been omitted for clarity.

The nut 400 is screwed onto the exposed end of the retaining device 100′ which has the effect of securely fastening the rod 300 into position and therefore making a rigid assembly which ensures that the requisite gap is maintained between the exposed surface of the connector 250 and the facing surface of the retaining device 100′ This gap is the same as the space filled by locking member 30 shown in FIGS. 5 and 6. The gap is indicated by 260.

Once the nut 400 is fully tightened it cannot travel any further and this configuration ensures that the gap 260 is properly dimensioned such that the rod 300 is properly retained and the entire assembly is rigid and secure.

FIG. 10 shows a sectional view of the completed assembly. This clearly shows how gap 260 is maintained and fixed, thereby ensuring the correct relationship between rod 300, retaining device 100′ connector 250.

Although described in herein in terms of a connector 250, it is noted that a connector 250 as shown is essentially just two receivers 200 back to back. The skilled person will realise that the embodiment of FIGS. 7 to 10 is equally applicable to the arrangements shown in the earlier Figures.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A retaining device comprising a pair of complementary members arranged such that when placed adjacent to each other, the retaining device is substantially annular and relatively elongate and comprises towards a first end thereof an inner circumferential ridge and an outer circumferential projection, and towards a second end thereof, means for connecting the pair of members, wherein adjacent said second end thereof there is provided a threaded portion for receiving a nut.

2. The retaining device of claim 1 wherein the means for connecting the pair of members comprises a circumferential channel arranged to receive a fastening means.

3. The retaining device of claim 2 wherein the fastening means is an O-ring or a spring clip.

4. The retaining device of claim 1 wherein each of the complementary members has a chamfered portion arranged to face a similarly chamfered portion of the other complementary member.

5. The retaining device of claim 4 wherein the chamfered portion is located towards the second end and on an inward facing surface.

6. The retaining device of claim 4 or 5 wherein the chamfered portions are arranged such that when means for connecting the pair of members is attached, the retaining device assumes a generally open configuration.

7. The retaining device of claim 1 further comprising a plurality of inner circumferential ridges.

8. The retaining device of claim 1 further comprising a nut.

9. The retaining device of claim 8 wherein the nut comprises a relatively elongate body comprising a means to engage with a tightening tool and further comprising an aperture arranged such that a castellated rod with pass therethrough.

10. The retaining device of claim 9 wherein the nut is dimensioned such that when fully tightened, the retaining device is configured to assume a fully locked and relatively rigid configuration.

11. A suspension system comprising the retaining device of claim 1, a receiver or connector arranged to receive the retaining device and a castellated rod.

12. A method of assembling a system comprising the retaining device of claim 1, comprising steps of:
providing a receiver or connector to receive a retaining device;
inserting the retaining device into the receiver or connector;
inserting a castellated rod into the receiver or connector such that it engages with the retaining device;
moving the castellated rod in an opposite direction to the insertion direction; and
affixing a nut to the exposed end of the retaining device and tightening such that the system becomes relatively fixed and rigid.
